(19) United States
(12) Patent Application Publication
(10) Pub. No.: US 2011/0087378 A1
(43) Pub. Date: Apr. 14, 2011

(54) CONTROL METHOD AND PROCESSOR OF EXHAUST GAS FLOW RATE OF PROCESSING CHAMBER

(75) Inventor: Dae-Hyun Kim, Gyeonggi-Do (KR)

(73) Assignee: TOKYO ELECTRON LIMITED, Tokyo (JP)

(21) Appl. No.: 12/933,941

(22) PCT Filed: Mar. 26, 2008
(86) PCT No.: PCT/JP2008/055705

§ 371 Date: Dec. 14, 2010

(51) Int. Cl. G05D 7/00

(52) U.S. Cl. 700/282

(57) ABSTRACT

To provide a method for controlling an exhaust gas flow rate so that flow of gas in a processing chamber becomes uniform. The control method of exhaust gas flow rate of the processing chamber having a pressure gauge and a plurality of exhaust pipe lines includes a step for measuring pressure in the processing chamber by using the pressure gauge, a step for deciding a total opening degree of the whole exhaust pipe lines so that measured pressure in the processing chamber becomes prescribed pressure, a step for distributing the total opening degree of the whole exhaust pipe lines to the opening degrees of the respective exhaust pipe lines and a step for controlling the flow rate of gas exhausted by adjusting the opening degrees of the exhaust pipe lines based on the opening degree which is set.

### FIELD OF THE INVENTION

The present invention relates to a control method of an exhaust gas flow rate of a processing chamber used for manufacturing a semiconductor, LCD, etc., and a processor having the processing chamber.

### BACKGROUND ART

In general, upon manufacturing a semiconductor or a liquid crystal display (LCD), etc., various processes such as an etching process, an ashing process, a chemical vapor deposition (CVD) process or a sputtering process are performed. Since theses processes are performed under a rigorous condition, the processing chamber which receives and processes a substrate needs to be maintained in a very clean state, and accordingly, each of the above processes is performed in a state that the remaining gas present in the processing chamber is completely exhausted to the outside and then the interior of the processing chamber is maintained in a low pressure by regulating the flow rates of the supplied reaction gas and the exhausted gas in a suitable manner.

The quantity of the reaction gas present in the processing chamber is determined according to various conditions such as the type of the process, the type of the reaction gas, a processing temperature and the size of the processing chamber and is maintained in a constant level during the process. For this reason, a pressure gauge is attached to the processing chamber, and the supply flow rate and the exhaust flow rate are regulated so that the pressure value in the processing chamber measured by the pressure gauge reaches a target pressure level.

Meanwhile, recently, since there is a tendency that the semiconductor becomes to be highly integrated and the device becomes to be larger, the need for maintaining not only the quantity of the reaction gas present in the processing chamber but also the flow of the reaction gas in the processing chamber to be uniform has been increased. For this reason, a method has been used for installing the air supply pipe line of the reaction gas in multiple pipe lines or for allowing the reaction gas in the processing chamber to pass through a gas diffusion plate.

### DISCLOSURE OF THE INVENTION

### Problems To Be Solved By The Invention

However, since the conventional method as described above dose not consider the exhaustion of the gas in the processing chamber, it is difficult to maintain the gas flow to be uniform as the processing chamber becomes to be a larger scale. Owing to the recent tendency of the semiconductor wafer or the LCD panel toward a large scale, the processing space in the processing chamber becomes to be wide, and thus it becomes more necessary to maintain the gas flow in the processing chamber to be uniform in consideration of the exhaust of the gas. For example, although, during a plasma etching process of a semiconductor substrate or a LCD substrate, the etching is performed by the reaction of the reaction gas and the substrate, the etching on the substrate becomes to be non-uniform when the gas flow is not uniform, and, as a result, the quality of the product becomes to be lower and the production yield is affected by the quality as well.

Meanwhile, as the processing chamber becomes a large scale, a plurality of vacuum pumps are required for maintaining the interior of the processing chamber in a vacuum or low pressure state. In this case, it is necessary to regulate the flow rate of the gas exhausted from each of the exhaust pipe lines communicating each vacuum pump in a suitable manner. For this reason, a method can be considered which regulates the flow rate of the gas exhausted from the respective exhaust pipe line by attaching a pressure gauge and an APC to the respective exhaust pipe line and regulating an opening degree of each APC based on the measured value of the pressure gauge. However, this method has a problem that expensive pressure gauges are necessary corresponding to the number of the exhaust pipe line.

Further, even if all of the flow rates of the gas exhausted from the respective exhaust pipe line are maintained in a constant level, the flow of the reaction gas in the processing chamber does not always necessarily become uniform. Also, even if the reaction gas is subjected to flowing through the upper portion of the processing chamber by using a gas diffusion plate, the gas dose not flow in an uniform state over the entire upper portion of the processing chamber when a difference in pressure gradient occurring under the gas diffusion plate is generated. For example, when a gate valve body or a fluid (e.g., cooling water) supply/discharge pipe line, etc., are disposed in the processing chamber, there is often the case that the flow rate of the gas becomes non-uniform due to the shape factor of the processing chamber.

The present invention has been made in view of the above problem in the prior art and the object thereof is to provide a method for controlling the exhaust gas flow rate so as to maintain the gas flow in the processing chamber to be uniform so that a desired process, such as, a plasma etching process is performed uniformly on the substrate.

### MEANS TO SOLVE THE PROBLEM

In order to achieve the above object, the present invention provides a method for controlling an exhaust gas flow rate of a processing chamber having a pressure gauge and a plurality of exhaust pipe lines. The method includes a step for measuring a pressure in the processing chamber by using the pressure gauge, a step for determining a total opening degree of the whole exhaust pipe lines so that the measured pressure in the processing chamber becomes a prescribed pressure value, a step for setting an opening degree of the respective exhaust pipe line by distributing the total opening degrees of the whole exhaust pipe lines to the opening degree of the respective exhaust pipe line, and a step for controlling the flow rate of the exhausted gas by adjusting the opening degree of the respective exhaust pipe line based on the set opening degree. Herein, it is preferred that the opening degree of the respective exhaust pipe line is regulated by an auto pressure controller (APC).

According to the present invention, it is possible to control the opening degree of the respective exhaust pipe line individually. As a result, it is possible to regulate the flow rate of the gas exhausted from the plurality of exhaust pipe lines by a vacuum pump independently, thereby maintaining the flow of the gas in the processing chamber to be uniform.

In the present invention, the step for determining the total opening degree of the whole exhaust pipe lines and the step for setting the opening degree of the respective exhaust pipe line may be performed by a microprocessor.

Also, in the present invention, the opening degree of the respective exhaust pipe line may be calculated by multiplying a predetermined opening ratio of the respective exhaust pipe line to a value obtained by equally distributing the total opening degree of the whole exhaust pipe line to the respective exhaust pipe line. As an alternative, the opening degree of the respective exhaust pipe line may be calculated by adding a predetermined offset amount of the opening degree of the respective exhaust pipe line to a value obtained by equally distributing the total opening degree of the whole exhaust pipe line to the respective exhaust pipe line. Preferably, the opening ratio or the offset amount of the opening degree of the respective exhaust pipe line is determined differently from each other depending upon the process condition of an experiment performed in advance.

By these configurations, it is possible to change the opening degree of the respective exhaust pipe line in a suitable manner, depending upon the process conditions such as the type of the process, the type of the gas inflowing/exhausting to and from the processing chamber, and the temperature and pressure of the processing chamber.

Meanwhile, in the present invention, the processing chamber may additionally include at least one air supply pipe line. Also, it is preferred that the plurality of exhaust pipe lines are disposed in a bottom surface of the processing chamber and a gas diffusion plate is further provided in an upper portion of the processing chamber. The gas diffusion plate may preferably be a porous plate having a plurality of venting holes.

By these configurations, it is possible to allow the flow of the gas in the processing chamber to be more uniform.

Also, it is preferred that the pressure gauge in the present invention is a capacitance manometer. By these configurations, the pressure of the processing chamber may be measured under the low pressure condition.

According to another aspect, the present invention provides a processing device including a processing chamber, a pressure gauge configured to measure a pressure within the processing chamber, a plurality of exhaust pipe lines configured to exhaust the gas within the processing chamber, and an exhaust control device configured to control the flow rate of the exhaust gas exhausted from the processing chamber. The exhaust control device is configured to determine the total opening degree of the whole exhaust pipe lines so that the pressure within the processing chamber measured by the pressure gauge becomes a prescribed pressure value, to set an opening degree of the respective exhaust pipe line by distributing the total opening degrees of the whole exhaust pipe lines to the opening degree of the respective exhaust pipe line, and to control the flow rate of the exhausted gas by adjusting the opening degree of the respective exhaust pipe line based on the set opening degree. Herein, the exhaust control device may be a microprocessor. Also, it is preferred that the opening degree of the respective exhaust pipe line set by the exhaust control device is regulated by an auto pressure controller (APC).

Also, in the present invention, the opening degree of the respective exhaust pipe line set by the exhaust control device may be calculated by multiplying a predetermined opening ratio of the respective exhaust pipe line to a value obtained by equally distributing the total opening degree of the whole exhaust pipe line to the respective exhaust pipe line. As an alternative, the opening degree of the respective exhaust pipe line set by the exhaust control device may be calculated by adding a predetermined offset amount of the opening degree of the respective exhaust pipe line to a value obtained by equally distributing the total opening degree of the whole exhaust pipe line to the respective exhaust pipe line. Preferably, the opening ratio or the offset amount of the opening degree of the respective exhaust pipe line is determined differently from each other depending upon the process condition of an experiment performed in advance.

Meanwhile, in the present invention, the processing chamber may include at least one air supply pipe line. Also, it is preferred that the plurality of exhaust pipe lines are disposed at the bottom surface of the processing chamber and a gas diffusion plate is further provided in an upper portion of the processing chamber. The gas diffusion plate may be a porous plate having a plurality of venting holes.

Further, it is preferred that the pressure gauge is a capacitance manometer.

### EFFECT OF THE INVENTION

According to the present invention, it is possible to control the opening degree of the respective exhaust pipe line individually and to regulate the flow rate of the gas exhausted from the exhaust pipe lines independently, thereby maintaining the flow of the gas in the processing chamber to be uniform.

### BRIEF DESCRIPTION OF THE DRAWINGS

FIG. 1 is a schematic view illustrating a configuration of a processing device having a processing chamber according to one embodiment of the present invention.

FIG. 2 is a view illustrating an arrangement of exhaust pipe lines at a bottom surface of the processing chamber.

FIG. 3 is a view illustrating an arrangement of exhaust pipe lines at a bottom surface of the processing chamber.

FIG. 4 is a view illustrating an arrangement of exhaust pipe lines at a bottom surface of the processing chamber.

FIG. 5 is a flow chart illustrating a method for controlling an exhaust gas flow rate of the processing chamber.

FIG. 6 is a view illustrating an opening ratio of each APC at the processing chamber.

FIG. 7 is a view illustrating an offset amount of an opening degree of each APC at the processing chamber.

FIG. 8 is a view illustrating the opening degree of each APC determined by the opening ratio shown in FIG. 6.

FIG. 9 is a view illustrating the opening degree of each APC determined by the offset amount of the opening degree shown in FIG. 7.

### EXPLANATION OF SYMBOL

10: processing device
100: processing chamber
106: air supply pipe line
108: gas diffusion plate
110: venting hole
112: exhaust pipe line
114: auto pressure controller (APC)
122: pressure gauge
126: exhaust control device

### DETAILED DESCRIPTION OF SEVERAL EMBODIMENTS

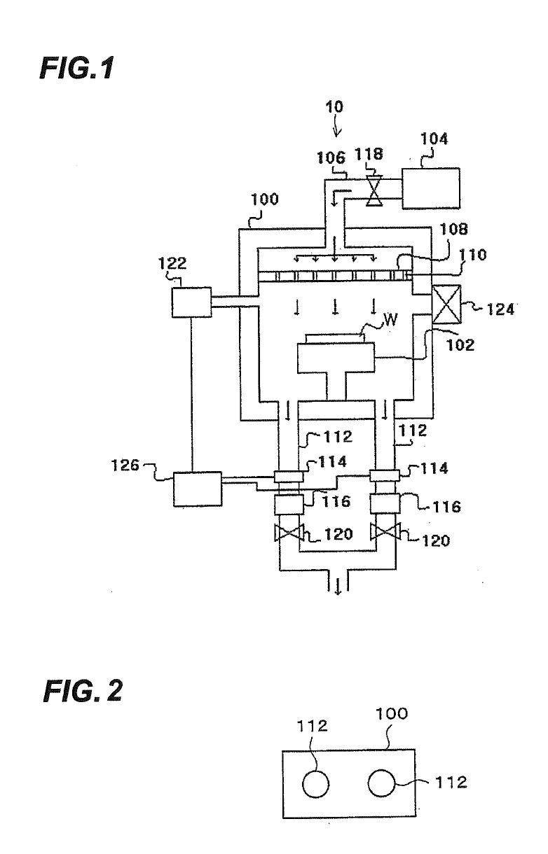

Hereinafter, a preferred embodiment of the present invention will be described. FIG. 1 is a schematic view illustrating a configuration of a processing device 10 having a processing chamber 100 according to the present embodiment. For example, in processing chamber 100, a substrate W is placed on a substrate placing table 102, and then a reaction gas is supplied to the processing chamber for performing various processes such as a plasma etching or a chemical vapor deposition.

Processing chamber 100 is provided at its upper surface with an air supply pipe line 106 communicating with a reaction gas source 104. The reaction gas flows from reaction gas source 104 through air supply pipe line 106 into processing chamber 100. For maintaining the flow of the reaction gas in processing chamber 100 to be uniform, a plurality of air supply pipe lines 106 may be disposed or a gas diffusion plate 108 may be provided at an upper part of processing chamber 100. Gas diffusion plate 108 is constituted by a porous plate having a plurality of venting holes 110. Upon processing substrate W in a process, it is normal to use multiple reaction gases, and accordingly, air supply pipe lines 106 may be separately provided for each of the multiple reaction gases or a branched pipe may be provided.

Processing chamber 100 is provided at its bottom surface with the plurality of exhaust pipe lines 112 each being mounted with an APC 114 and a vacuum pump 116 in this order from processing chamber 100. APC 114 is a kind of a valve body regulating the flow rate of the gas and can be classified roughly into a pendulum type and a butterfly type. The pendulum type APC is configured to allow a pendulum member to open/close exhaust pipe lines 112 thereby moving in a direction perpendicular to the flow direction of the gas, and the butterfly type APC is configured to allow a valve body to open/close exhaust pipe lines 112 thereby rotating about an axis provided in exhaust pipe lines 112. In the present embodiment, any type of APC may be used and an opening degree of exhaust pipe lines 112 is adjusted by the opening degree of the valve body of APC 114.

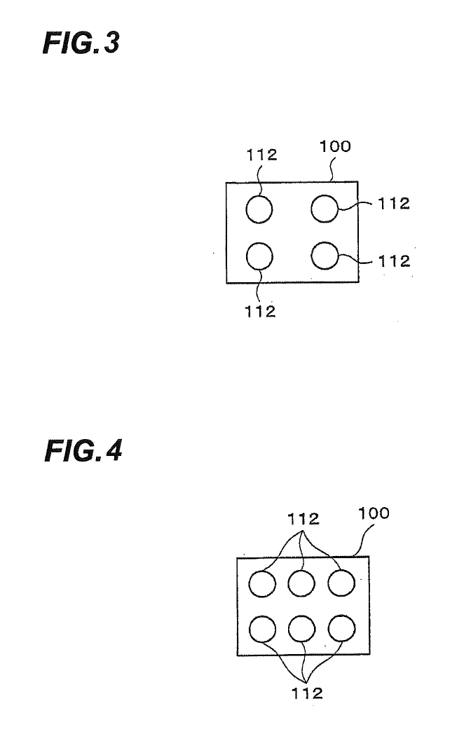

In the present embodiment, two or more exhaust pipe lines 112 may be disposed. For example, FIG. 2, FIG. 3 and FIG. 4 each illustrates a state that two, four, and six exhaust pipe lines 112 are disposed, respectively, at the bottom surface of processing chamber 100. Although each exhaust pipe line 112 may be arranged at a predetermined position in the bottom surface of processing chamber 100, so as to allow the flow of the gas in processing chamber 100 to be uniform, it is preferred that the exhaust pipe lines are symmetrically disposed about a center line of the bottom surface as shown. Hereinafter, an embodiment in which four exhaust pipe lines are disposed as shown in FIG. 3, will be described as an example.

Vacuum pump 116 is a device for depressurizing the interior of processing chamber 100 and is configured to exhaust a gas such as non-reaction gas or a reaction product present in processing chamber 100. For example, a turbo molecular pump may be used as vacuum pump 116. A drive pump (not shown) for aiding the start of vacuum pump 116 may be installed at a downstream of vacuum pump 116, and vacuum pump 116 can be installed in multiple states for increasing the exhaust capability. Also, the plurality of exhaust pipe lines 112 may be joined to one line at a downstream of each vacuum pump 116, and this exhaust pipe line 112 is finally connected to a general exhaust system in the factory or an external line. Meanwhile, a shut-off valve body 118, 120 for blocking the flow of the gas may be attached to air supply pipe line 106 and exhaust pipe lines 112.

A pressure gauge 122 for measuring a pressure in processing chamber 100 is attached to processing chamber 100. Pressure gauge 122 may be attached to an arbitrary position of processing chamber 100, but in this embodiment, the pressure gauge is connected to processing chamber 100 through a venting hole formed at a side surface of processing chamber 100. For example, a capacitance manometer may be used as pressure gauge 122.

In addition to this, various attachments or elements can be installed in processing chamber 100. For example, a gate valve body 124 for transferring substrate W may be installed in the processing chamber, and although not illustrated, a fluid supplying/exhausting pipe line, a power supply wiring, a substrate elevating/transferring device, a plasma applying device etc., may be installed in processing chamber 100, depending upon process conditions.

In the present embodiment, the measured values of pressure gauge 122 are sent to an exhaust control device 126. Exhaust control device 126 is configured to set an optimal opening degree of each APC 114 based on the pressure value in processing chamber 100 measured by pressure gauge 122 and to adjust the opening degree of APC 114 based on the set opening degree. And, the exhaust control device can regulate the flow rate of the gas exhausted from the respective exhaust pipe line 112 by vacuum pump 116. Exhaust control device 126 may be constituted by a microprocessor, or may store a memory therein, or may further include a memory device. The memory stores the opening ratio or the offset amount of the opening degree of each APC 114 adapted to the process condition.

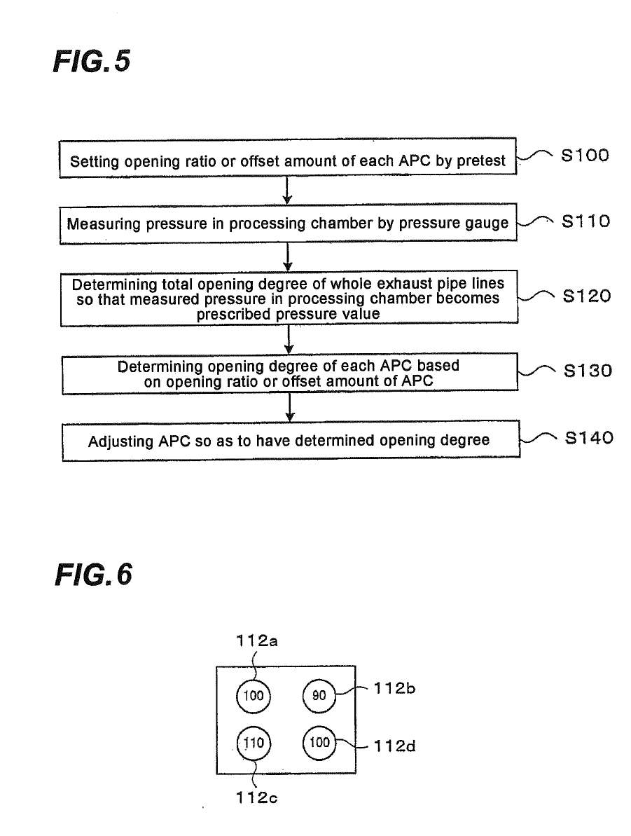

Hereinafter, an operation and effect of the control method of an exhaust gas flow rate of processing chamber 100 according to the present invention will be described. FIG. 5 is a flow chart illustrating a method for controlling an exhaust gas flow rate of processing chamber 100 in the embodiment of the present invention.

Firstly, step S100 is a step performed prior to controlling of the exhaust gas flow rate and is adapted to determine the opening ratio or the offset amount of the opening degree of each APC 114 by a process test performed in advance. As mentioned above, even if the reaction gas flows into processing chamber 100 in a relatively uniform state, the flow of the reaction gas becomes to be disturbed due to various equipments installed in processing chamber 100. Accordingly, it is insufficient for the flow of the gas in processing chamber 100 to be uniform, merely by maintaining the flow rate of the gas exhausted from the respective exhaust pipe line 112 to be uniform. Also, it is necessary to increase or decrease the supply quantity of the reaction gas into some regions of respective processing chamber 100, in some process. For example, in a plasma etching process, so as to allow the etching amount of some regions of substrate W to be larger than that of another region thereof, it is necessary to increase the supply quantity of the reaction gas toward the some regions, and in this case, it is necessary to increase the velocity of the gas toward the some region thereof. For this purpose, it is necessary to increase the opening degree of APC 114 attached to exhaust pipe line 112 adjacent to the region of which velocity has to be increased.

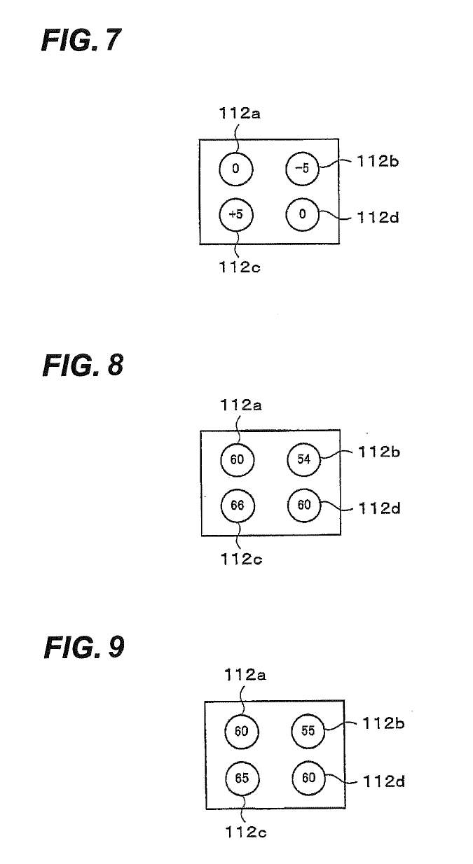

Accordingly, at step S100, a pretest is performed according to the plurality of process conditions as mentioned above so as to set a setting value which becomes a criteria as to how the opening degree of each APC 114 is distributed. For example, this setting value is determined by providing a suitable opening ratio to each APC 114 as shown in FIG. 6 or by providing a suitable offset amount of the opening degree to each APC 114 as shown in FIG. 7. In FIG. 6 and FIGS. 7, 112a, 112b, 112c and 112d designate exhaust pipe lines respectively, and the numbers written in the exhaust pipe lines at these figures designate an opening ratio or an offset amount of the opening degree of APC 114 attached to the respective exhaust pipe line. For example, in FIG. 6, opening ratio 90 of exhaust pipe line 112b means that the opening ratio is at 90% level of a standard opening degree, and similarly opening ratio 110 of exhaust pipe line 112c means that the opening ratio is at 110% level of the standard opening degree. Further, in FIG. 7, offset amount −5 of exhaust pipe line 112b means that the offset amount is at a level obtained by subtracting 5 from the standard opening degree, and similarly offset amount +5 of exhaust pipe line 112c means that the offset amount is at a level obtained by adding 5 to the standard opening degree. In this way, the present invention is adapted to allow the flow of the gas to be uniform by setting the opening degree of each APC 114 individually, or, if necessary, to increase/decrease the gas velocity of some region. Further, since the opening degree of each APC 114 can be determined by the pretest, it is possible to have different opening degrees according to various process conditions.

Next, step S110 is a step for measuring the pressure in processing chamber 100 by using a pressure gauge 122. In the present invention, since it is not necessary to attach pressure gauge 122 to each exhaust pipe line 112, and as shown in FIG. 1, it is sufficient to attach one pressure gauge 114 to processing chamber 100, it is possible to establish an economic exhaust system, even if the plurality of exhaust pipe lines 112 are provided in the processing chamber.

Step S120 is a step for determining a total opening degree of whole APC 114 by using the pressure in processing chamber 100 measured at step S110. If the opening degree is referred to as 100 when APC 114 is entirely open and the opening degree is referred to as 0 when APC is entirely closed, the total opening degree of APC 114 in the present embodiment is determined within a range of 0˜400. If the measured pressure in processing chamber 100 is larger than a prescribed pressure value required for performing a process, it is necessary to increase the flow rate of the exhaust gas by making the total opening degree of APC 114 larger than current total opening degree. In the contrary, if the measured pressure in processing chamber 100 is smaller than the prescribed pressure value required for performing a process, it is necessary to decrease the flow rate of the exhaust gas by making the total opening degree of APC 114 smaller than current total opening degree. Herein, a case that the total opening degree of APC 114 is determined as 240, will be described as an example.

Step S130 is a step for determining the opening degree of each APC 114 based on the opening ratio or the offset amount of the opening degree of each APC 114 set by step S100. Firstly, a value obtained by equally distributing the total opening degree of APC 114 to each APC 114 is referred to as an average value or a reference value of the total opening degree. In this embodiment, the value becomes 60. Next, the opening degree of each APC 114 is determined by multiplying a predetermined opening ratio of each APC 114 to the reference value or by adding a predetermined offset amount of the opening degree of each APC 114 to the reference value. For example, if the opening ratio of each APC 114 is determined as shown in FIG. 6, the opening degree of each APC 114 is determined as shown in FIG. 8, by multiplying each opening ratio to the reference value of the opening degree. Similarly, if the offset amount of the opening degree of each APC 114 is determined as shown in FIG. 7, the opening degree of each APC 114 is determined as shown in FIG. 9, by adding each offset amount to the reference value of the opening degree. Although the opening degree of each APC 114 is calculated by using the opening ratio or the offset amount of the opening degree in the present embodiment, the opening degree of each APC 114 may be calculated by using any other method. For example, it may be possible to employ a method for creating a database individually for the opening degree of each APC 114 based on various process conditions and the measured pressure in processing chamber 100 or it may be possible to employ a method for determining the opening degree of each APC 114 by using a function of the process condition and the measured pressure in processing chamber 100.

Finally, at step S140, the flow rate of the gas exhausted from each exhaust pipe line 112 by vacuum pump 116 is regulated by adjusting each APC 114 based on the opening degree determined at the step S130.

By controlling the exhaust gas flow rate of processing chamber 100 using a method mentioned above, it is possible to control the flow of the gas in processing chamber 100 for facilitating the process to be performed. Further, it is possible to realize the opening degree of APC 114 suitable for the process condition by using an economic method.

From the foregoing, preferred embodiments of the present invention are described by referring to accompanying drawings. However, the present invention is not limited thereto. It will be appreciated that those skilled in the art can derivate various modifications and revises within the scope and spirit claimed in following clams, and also these modifications and revises fall within the scope of the present invention.

### Industrial applicability

The present invention relates to a control method of an exhaust gas flow rate of a processing chamber used for manufacturing a semiconductor, a LCD, etc., and a processing device having the processing chamber.

1. A method for controlling an exhaust gas flow rate of a processing chamber having a pressure gauge and a plurality of exhaust pipe lines, the method is comprising:
measuring a pressure in the processing chamber by using the pressure gauge;
determining a total opening degree of the whole exhaust pipe lines so that the measured pressure in the processing chamber becomes a prescribed pressure value;
setting an opening degree of the respective exhaust pipe line by distributing the total opening degrees of the whole exhaust pipe lines to the opening degree of the respective exhaust pipe line; and
controlling the flow rate of the exhausted gas by adjusting the opening degree of the respective exhaust pipe line based on the set opening degree.

2. The method as claimed in claim 1, wherein the determining the total opening degree of the whole exhaust pipe lines and the setting the opening degree of the respective exhaust pipe line are performed by a microprocessor.

3. The method as claimed in claim 1, wherein the opening degree of the respective exhaust pipe line is calculated by multiplying a predetermined opening ratio of the respective exhaust pipe line to a value obtained by equally distributing the total opening degree of the whole exhaust pipe line to the respective exhaust pipe line.

4. The method as claimed in claim 3, wherein the opening ratio of the respective exhaust pipe line is determined differently from each other depending upon the process condition of an experiment performed in advance.

5. The method as claimed in claim 1, wherein the opening degree of the respective exhaust pipe line is calculated by adding a predetermined offset amount of the opening degree of the respective exhaust pipe line to a value obtained by equally distributing the total opening degree of the whole exhaust pipe line to the respective exhaust pipe line.

6. The method as claimed in claim 5, wherein the offset amount of the opening degree of the respective exhaust pipe line is determined differently from each other depending upon the process condition of an experiment performed in advance.

7. The method as claimed in claim 1, wherein the processing chamber includes one or more air supply pipe lines.

8. The method as claimed in claim 1, wherein the plurality of exhaust pipe lines are disposed in a bottom surface of the processing chamber.

9. The method as claimed in claim 1, wherein a gas diffusion plate is further provided in an upper portion of the processing chamber.

10. The method as claimed in claim 9, wherein the gas diffusion plate is a porous plate having a plurality of venting holes.

11. The method as claimed in claim 1, wherein the pressure gauge is a capacitance manometer.

12. The method as claimed in claim 1, wherein the opening degree of the respective exhaust pipe line is regulated by an auto pressure controller (APC).

13. A processor including a processing chamber, the processor comprising:
a pressure gauge configured to measure a pressure within the processing chamber;
a plurality of exhaust pipe lines configured to exhaust the gas within the processing chamber; and
an exhaust control device configured to control the flow rate of the exhaust gas exhausted from the processing chamber,
wherein the exhaust control device is configured to determine a total opening degree of the whole exhaust pipe lines so that the pressure within the processing chamber measured by the pressure gauge becomes a prescribed pressure value, to set an opening degree of the respective exhaust pipe line by distributing the total opening degrees of the whole exhaust pipe lines to the opening degree of the respective exhaust pipe line, and to control the flow rate of the exhausted gas by adjusting the opening degree of the respective exhaust pipe line based on the set opening degree.

14. The processor as claimed in claim 13, wherein the exhaust control device is a microprocessor.

15. The processor as claimed in claim 13, wherein the opening degree of the respective exhaust pipe line set by the exhaust control device is calculated by multiplying a predetermined opening ratio of the respective exhaust pipe line to a value obtained by equally distributing the total opening degree of the whole exhaust pipe line to the respective exhaust pipe line.

16. The processor as claimed in claim 15, wherein the opening ratio of the respective exhaust pipe line is determined differently from each other depending upon the process condition of an experiment performed in advance.

17. The processor as claimed in claim 13, wherein the opening degree of the respective exhaust pipe line set by the exhaust control device is calculated by adding a predetermined offset amount of the opening degree of the respective exhaust pipe line to a value obtained by equally distributing the total opening degree of the whole exhaust pipe line to the respective exhaust pipe line.

18. The processor as claimed in claim 17, wherein the offset amount of the opening degree of the respective exhaust pipe line is determined differently from each other depending upon the process condition of an experiment performed in advance.

19. The processor as claimed in claim 13, wherein the processing chamber includes one or more air supply pipe lines.

20. The processor as claimed in claim 13, wherein the plurality of exhaust pipe lines are disposed at the bottom surface of the processing chamber.

21. The processor as claimed in claim 13, wherein a gas diffusion plate is further provided in an upper portion of the processing chamber.

22. The processor as claimed in claim 21, wherein the gas diffusion plate is a porous plate having a plurality of venting holes.

23. The processor as claimed in claim 13, wherein the pressure gauge is a capacitance manometer.

24. The processor as claimed in claim 13, wherein the opening degree of the respective exhaust pipe line set by the exhaust control device is regulated by an auto pressure controller (APC).
